(19) United States
(12) Patent Application Publication
(10) Pub. No.: US 2006/0230447 A1
(43) Pub. Date: Oct. 12, 2006

(54) User interface component identifying authorization check

(76) Inventor: Cristina Buchholz, Reilingen (DE)

Correspondence Address: FISH & RICHARDSON, P.C., PO BOX 1022, MINNEAPOLIS, MN, 55440-1022, US

(21) Appl. No.: 11/103,716

(22) Filed: Apr. 12, 2005

(51) Int. Cl. G06F 12/14

(52) U.S. Cl. 726/17

(57) ABSTRACT

Providing identification of an authorization check includes creating a UI component to display data content in a GUI, wherein user access to the data content requires at least one authorization check. The method includes associating the UI component with the at least one authorization check such that, upon the UI component being implemented, the at least one authorization check is identified for providing a user with at least one authorization for the at least one authorization check. Providing authorization to a user includes receiving a UI component to display data content in a GUI, the UI component having an association with at least one authorization check required for a user to access the data content. The method includes providing at least one authorization for the at least one authorization check to the user, the at least one authorization being identified using the association.

### TECHNICAL FIELD

The description relates to a user interface component that identifies at least one authorization check required for user access to data content.

### BACKGROUND

The working environment of e-business is characterized by open networks and cross-company business transactions, replacing closed and monolithic systems. In this environment, secure data access is a central aspect of doing business. As a result, access to digital information is typically managed using one or more authorizations. Also, in the world of Web services, access will depend more and more on authorization. In this environment, ways of rationalizing the authorization process and authorization status will be key.

One area of some difficulty in existing systems is the process of identifying the authorization checks that apply to a user's access to particular data. Part of the reason is that authorization checks can be distributed in any of several system layers. Locating such checks individually and obtaining the necessary authorizations can be a work intensive process. Also, there is not a distinct connection between, on one hand, the components in a graphical user interface (GUI) layer and, on the other the authorizations required for accessing the corresponding data content.

Existing approaches in this area include role-based authorization systems where each user is assigned one or more roles that determine what authorizations the user should have. A role typically covers all activities that a user can perform using a specific application. In other words, the level of granularity in assigning authority using roles is low. There are systems that include roles upon delivery; that is, where pre-delivery roles are defined before the customer initiates the system. Such roles may not be useful to many customers, because they grant a relatively far-reaching authority that is not applicable to the customer's business. Moreover, modifying the role may be difficult and may to some extend eliminate the intended advantage of the pre-delivery role. Accordingly, some experience indicates that customers disfavor pre-delivery roles.

### SUMMARY

The invention relates to identifying authorization checks for data content.

In a first general aspect, the invention includes a method of providing that an authorization check for data content is identified. The method comprises creating a user interface component to display data content in a graphical user interface, wherein user access to the data content requires at least one authorization check. The method comprises associating the user interface component with the at least one authorization check such that, upon the user interface component being implemented, the at least one authorization check is identified for providing a user with at least one authorization for the at least one authorization check.

In selected embodiments, the user interface component is associated with the at least one authorization check through a link in the user interface component. The user interface component may relate to an aspect of a business process, wherein the at least one authorization is required for the user to perform the aspect of the business process. The user interface component may be included in a work center software module, and assigning the user to the work center software module may trigger identification of the at least one authorization check for providing the user with the at least one authorization. It may be provided that the at least one authorization is stored in association with the work center software module. The aspect may be at most two steps of the business process. The at most two steps may relate to user-initiated generation of a document. The at most two steps may relate to user-initiated verification of a document.

In a second general aspect, the invention includes a method of providing authorization for data content to a user. The method comprises receiving a user interface component to display data content in a graphical user interface, the user interface component having an association with at least one authorization check required for a user to access the data content. The method further comprises providing at least one authorization for the at least one authorization check to the user, the at least one authorization being identified using the association.

In selected embodiments, the association is a link in the user interface component. The user interface component may relate to an aspect of a business process, wherein the at least one authorization is required for the user to perform the aspect of the business process. The user interface component may be included in a work center software module, and assigning the user to the work center software module may trigger identification of the at least one authorization check for providing the user with the at least one authorization. The at least one authorization may be stored in association with the work center software module. The aspect may be at most two steps of the business process. The at most two steps may relate to user-initiated generation of a document. The at most two steps may relate to user-initiated verification of a document.

Advantages of the systems and techniques described herein may include any or all of the following: Providing an improved UI component that identifies the authorization checks for the data content of the component; providing a simplified procedure for assigning authorizations to a user; providing an improved structure for managing authorizations; and providing authorizations at an improved granularity level.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a computer system using authorizations;

FIG. 2 shows a block diagram of a work center software module that is associated with authorization checks;

FIG. 3 shows an exemplary GUI for assigning a user to a work center;

FIG. 4 shows an example of a work center GUI;

FIGS. 5 and 6 show embodiments of inventive methods; and

FIG. 7 is a block diagram of a general computer system.

Like reference numerals in the various drawings indicate like elements.

### DETAILED DESCRIPTION

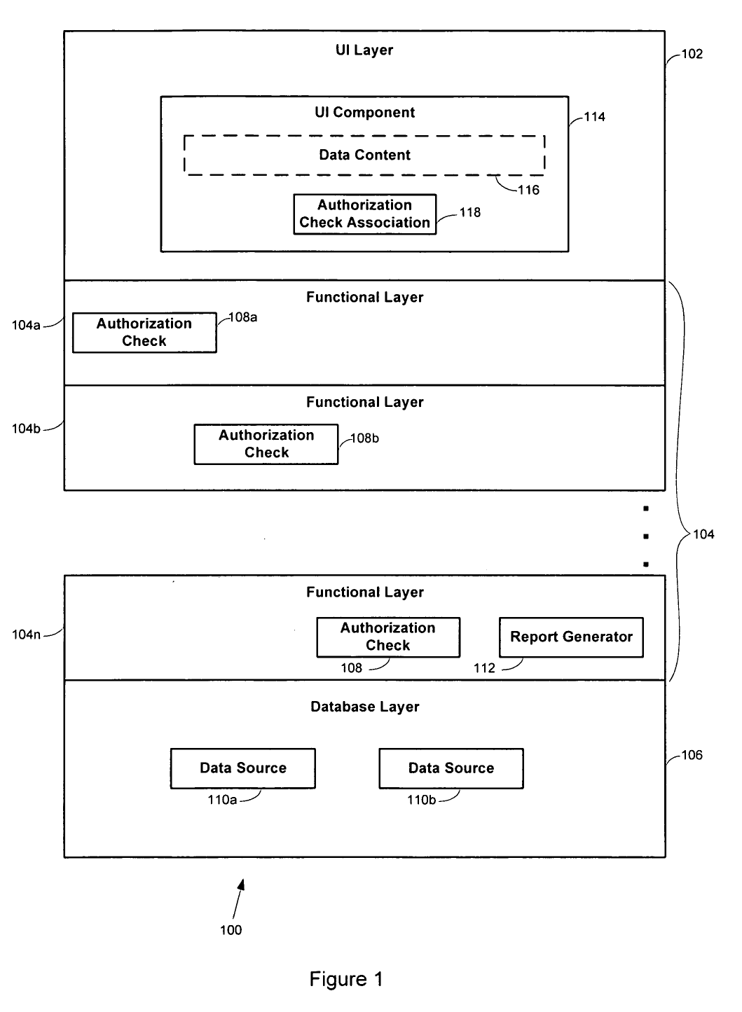

FIG. 1 shows an exemplary system 100 that uses authorizations. The system includes several layers, including a UI layer 102, one or more functional layers 104, and a database layer 106. Authorization checks may exist at any or all of the layers. Particularly, each of the functional layers 104a, 104b, . . . , 104n may include at least one authorization check 108a, 108b, . . . , 108n. Each authorization check may be invoked upon a user seeking access to specific data in the system. For example, different authorization checks may apply to data obtained from respective data sources 110a and 110b in the database layer. As another example, a report generator 112 may output a report that includes analyzed or otherwise processed data, and access to such a report may require appropriate authorization.

The system may include one or more UI components 114 by which a user can view and perhaps edit data content 116. As an example, the data content is part of the report from the report generator 112. The system requires proper authorization for the user to view or edit the data content. The UI component includes an association 118 with one or more of the authorization checks 108a, 108b, . . . , 108n. The association 118 identifies the authorization check(s) that are required for the data content. Upon implementing the UI component 114, the association 118 provides convenient identification of the required authorization checks so that the user can be given the proper authorization(s). That is, the user can be assigned to the UI component as a first step in providing access to data content, and the association 118 can be used in identifying the necessary authorizations. Association 118 may be a link to the proper authorization check.

The data access restrictions may be organized according to a division between functional authorizations and instance-based authorizations. A functional authorization may authorize the user to perform certain actions in the system, such as maintaining (creating, reading, updating, deleting) a category of records, or merely reading such records. An instance-based authorization, in contrast, identifies the instance(s) of the record category upon which the user can perform such actions (for example, the user can maintain all records associated with a specific city.) Moreover, the functional authorization may relate to an aspect of a business process, such as issuing invoices, verifying or approving invoices, or releasing goods. Thus, the aspect may be specified at a relatively fine level of granularity to provide flexibility in distributing the authority among users. For example, the authorized aspect may be confined to one or two steps of the business process.

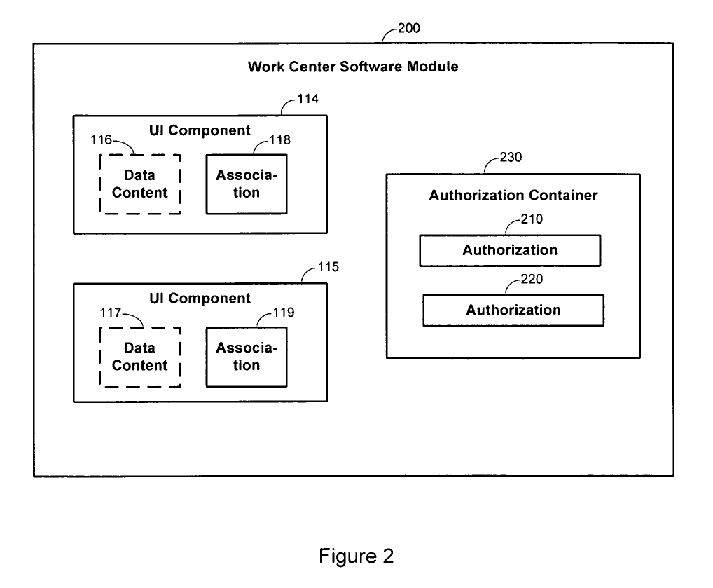

Authorizations may be automatically identified and provided upon a user being assigned to a software module for the corresponding data content. FIG. 2 shows an example of a work center software module 200 (“work center”). One or more users may be granted authorization to the work center's data content by associating the user(s) with the work center. The work center can include one or more UI components. Here, the UI component 114 and a second UI component 115 are included in the work center 200. The second UI component relates to data content 117 and is associated with the required authorization check through an association 119. Upon the user being assigned to the work center, the system can determine, using the associations 118 and 119, that the user needs respective authorizations 210 and 220. Due to the associations included in the UI components, the authorization checks are identified no matter how “deep” the authorization checks lie in the layer structure of the system 10. The work center may include an authorization container 230 in which to store the authorizations. The authorizations may be placed in the container before any user is assigned to the work center. For example, the work center with its associated UI component(s) and authorization(s) may be generated before the system is delivered to the customer.

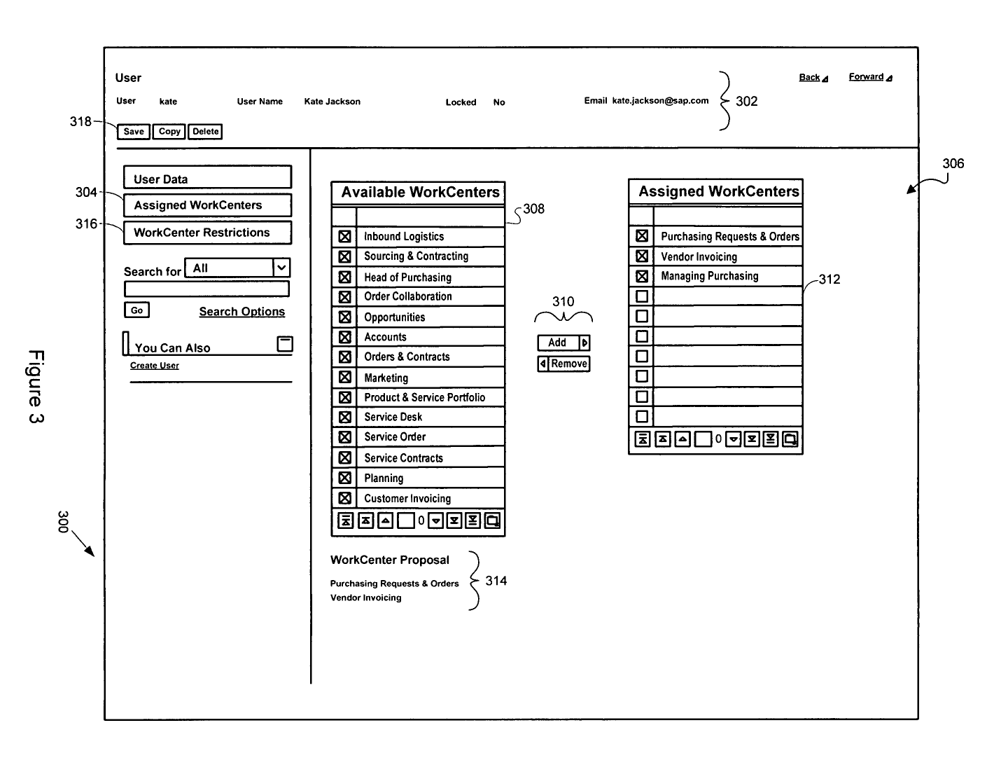

FIG. 3 shows an exemplary GUI 300 that can be used to assign a user to one or more work centers. The GUI displays user information 302. Upon selection of an “Assigned WorkCenters” control 304, particular content is displayed in a work area 306. A first area 308 identifies one or more work centers that the user can be assigned to. Controls 310 can be used to add or remove a particular work center from an area 312 that lists the work centers to which the user is currently assigned. For example, this user is assigned to three work centers: Purchasing Requests & Orders, Vendor Invoicing and Managing Purchasing. Also, a proposal area 314 can list one or more work centers that the system proposes for this particular user. For example, the user may have been assigned to a specific node or level in an organizational hierarchy of the customer organizations. This node or level, in turn, may be associated with certain work centers to be proposed for its users. Here, the proposal area 314 lists two proposed work centers. Upon a “WorkCenter Restrictions” control 316 being selected, it is possible to define, also in the work area 306, the object instances that the user should be able to reach through this work center. Changes made in the GUI are saved using a control 318.

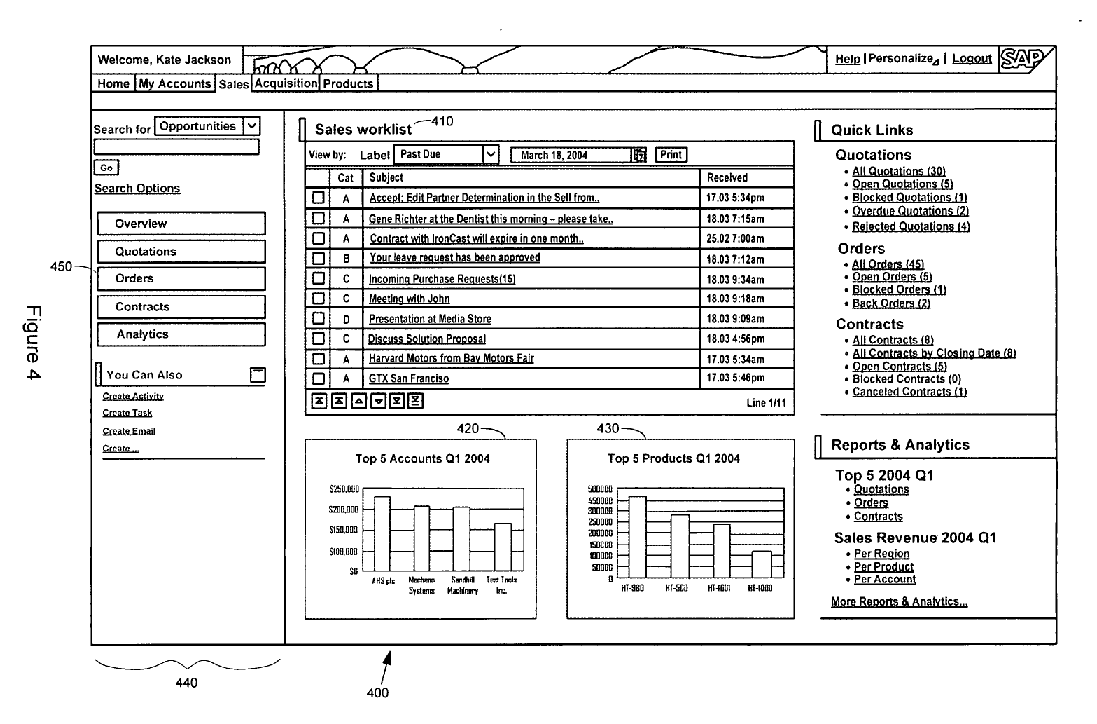

FIG. 4 is an example of a work center 400 that displays data content. The work center includes one or more UI components for presenting data content that is protected by authorization checks. The UI components underlying the work center are associated with the respective authorization checks so that the proper authorizations can be provided to the user. Here, the work center provides the authorized user access to a sales work list 410 and two preview areas: an accounts area 420 and a products area 430. For example, the areas 420 and 430 may include data generated by the report generator 112. A navigation area 440 includes available options, such as an Orders control 450 for navigating to an area where the user can perform predefined activities relating to orders. Because the user is assigned to the work center, the user is provided the authorizations for performing the tasks available in the work center.

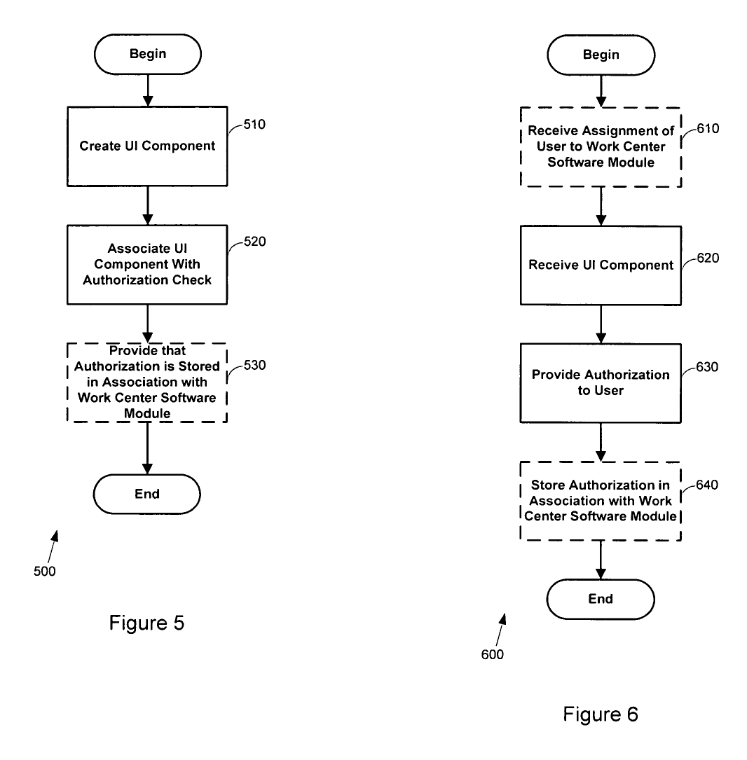

FIG. 5 shows a flow chart of an exemplary method 500 of providing that an authorization check for data content is identified. The method 500 can be performed using a computer program product, that is, by a processor executing instructions stored in a computer readable medium. The method 500 comprises:

Creating, in step 510, a UI component to display data content in a GUI. At least one authorization check must be performed for user access to the data content. For example, this step may include creating any of the UI components 114 or 115, or the UI component for any of the areas 420 or 430.

Associating, in step 520, the UI component with the at least one authorization check. The association is made such that, upon the UI component being implemented, the at least one authorization check is identified for providing the user with at least one corresponding authorization. For example, this step may include creating any of the associations 118 or 119, or the association for the UI component underlying any of the previews 420 or 430. Creating the UI component (step 510) can include associating the UI component with the authorization check (step 520).

Optionally providing, in step 530, that the authorization is stored in association with a work center software module. For example, the work center 400 may be provided with the authorization container 230 for storing the authorizations required for access to the sales work list 410 and areas 420 and 430, as well as other authorizations.

FIG. 6 shows a flow chart of an exemplary method 600 of providing authorization for data content to a user. The method 600 can be performed using a computer program product, that is, by a processor executing instructions stored in a computer readable medium. The method 600 comprises:

Optionally receiving, in step 610, an input to assign a user to a work center software module. For example, the system 100 may receive such an input when the user is assigned to a work center in the GUI 300. The system may propose the work center for the user.

Receiving, in step 620, a UI component to display data content in a graphical user interface. The user interface component has an association with at least one authorization check required for a user to access the data content. For example, the system 100 receives any of the UI components 114 or 115, or the UI component underlying any of the areas 420 or 430, when they are implemented. The UI component may be included in a work center.

Providing, in step 630, at least one authorization for the at least one authorization check to the user. The at least one authorization is identified using the association. For example, the association 118 may be used in providing the authorization 210 to the user.

Optionally storing, in step 640, the authorization in association with a work center software module. For example, the authorizations 210 and 220 are stored in the authorization container 230.

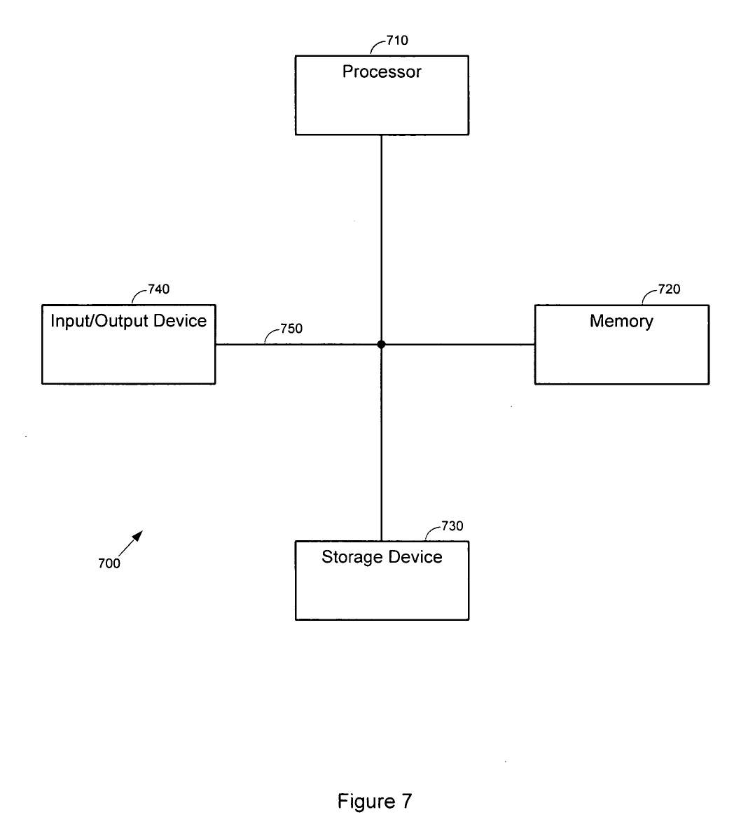

FIG. 7 is a block diagram of a computer system 700 that can be used in the operations described above, for example in the system 100. The system 700 includes a processor 710, a memory 720, a storage device 730 and an input/output device 740. Each of the components 710, 720, 730 and 740 are interconnected using a system bus 750. The processor 710 is capable of processing instructions for execution within the system 700. In one embodiment, the processor 710 is a single-threaded processor. In another embodiment, the processor 710 is a multi-threaded processor. The processor 710 is capable of processing instructions stored in the memory 720 or on the storage device 730 to display graphical information for a user interface on the input/output device 740.

The memory 720 stores information within the system 700. In one embodiment, the memory 720 is a computer-readable medium. In one embodiment, the memory 720 is a volatile memory unit. In another embodiment, the memory 720 is a non-volatile memory unit.

The storage device 730 is capable of providing mass storage for the system 700. In one embodiment, the storage device 730 is a computer-readable medium. In various different embodiments, the storage device 730 may be a floppy disk device, a hard disk device, an optical disk device, or a tape device.

The input/output device 740 provides input/output operations for the system 700. In one embodiment, the input/output device 740 includes a keyboard and/or pointing device. In one embodiment, the input/output device 740 includes a display unit for displaying graphical user interfaces. For example, the input/output device can generate any or all GUIs described herein.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method of providing that an authorization check for data content is identified, the method comprising:
creating a user interface component to display data content in a graphical user interface, wherein user access to the data content requires at least one authorization check; and
associating the user interface component with the at least one authorization check such that, upon the user interface component being implemented, the at least one authorization check is identified for providing a user with at least one authorization for the at least one authorization check.

2. The method of claim 1, wherein the user interface component is associated with the at least one authorization check through a link in the user interface component.

3. The method of claim 1, wherein the user interface component relates to an aspect of a business process, wherein the at least one authorization is required for the user to perform the aspect of the business process.

4. The method of claim 3, wherein the user interface component is included in a work center software module, and wherein assigning the user to the work center software module triggers identification of the at least one authorization check for providing the user with the at least one authorization.

5. The method of claim 4, further comprising providing that the at least one authorization is stored in association with the work center software module.

6. The method of claim 3, wherein the aspect is at most two steps of the business process.

7. The method of claim 6, wherein the at most two steps relate to user-initiated generation of a document.

8. The method of claim 6, wherein the at most two steps relate to user-initiated verification of a document.

9. A computer program product tangibly embodied in an information carrier, the computer program product including instructions that, when executed, cause a processor to perform operations comprising:
creating a user interface component to display data content in a graphical user interface, wherein user access to the data content requires at least one authorization check; and
associating the user interface component with the at least one authorization check such that, upon the user interface component being implemented, the at least one authorization check is identified for providing a user with at least one authorization for the at least one authorization check.

10. A method of providing authorization for data content to a user, the method comprising:
receiving a user interface component to display data content in a graphical user interface, the user interface component having an association with at least one authorization check required for a user to access the data content; and
providing at least one authorization for the at least one authorization check to the user, the at least one authorization being identified using the association.

11. The method of claim 10, wherein the association is a link in the user interface component.

12. The method of claim 10, wherein the user interface component relates to an aspect of a business process, wherein the at least one authorization is required for the user to perform the aspect of the business process.

13. The method of claim 12, wherein the user interface component is included in a work center software module, and wherein assigning the user to the work center software module triggers identification of the at least one authorization check for providing the user with the at least one authorization.

14. The method of claim 13, further comprising storing the at least one authorization in association with the work center software module.

15. The method of claim 12, wherein the aspect is at most two steps of the business process.

16. The method of claim 15, wherein the at most two steps relate to user-initiated generation of a document.

17. The method of claim 15, wherein the at most two steps relate to user-initiated verification of a document.

18. A computer program product tangibly embodied in an information carrier, the computer program product including instructions that, when executed, cause a processor to perform operations comprising:
receiving a user interface component to display data content in a graphical user interface, the user interface component having an association with at least one authorization check required for a user to access the data content; and
providing at least one authorization for the at least one authorization check to the user, the at least one authorization being identified using the association.
